(19) United States
(12) Patent Application Publication
(10) Pub. No.: US 2024/0279383 A1
(43) Pub. Date: Aug. 22, 2024

(54) THERMOPLASTIC POLYURETHANE AND ARTICLES THEREOF

(71) Applicant: BASF SE, Ludwigshafen am Rhein (DE)

(72) Inventors: Mark D SWARTZLANDER, Wyandotte, MI (US); Charles L Tazzia, Wyandotte, MI (US)

(73) Assignee: BASF SE, Ludwigshafen am Rhein (DE)

(21) Appl. No.: 18/293,435

(22) PCT Filed: Aug. 3, 2022
(86) PCT No.: PCT/EP2022/071883

§ 371 Date: Jan. 30, 2024

Related U.S. Application Data
(60) Provisional application No. 63/229,580, filed on Aug. 5, 2021.

(30) Foreign Application Priority Data
Apr. 20, 2022 (EP) 22168958.1

(51) Int. Cl. C08G 18/48; A01G 25/02; C08G 18/32; C08G 18/72; C08G 18/79

(52) U.S. Cl. CPC C08G 18/4854; C08G 18/3203; C08G 18/721; C08G 18/797; A01G 25/023

(57) ABSTRACT

A thermoplastic polyurethane (TPU) formed as a reaction product of a polyol composition, at least one chain extender, at least one triol and an isocyanate composition can be made. An irrigation device which has an emitter defined by a body, a cover and at least a membrane and an irrigation hose can be produced, wherein the membrane is made of the TPU. The TPU can be used for production of injection molded products, extrusion products, films, perforated films, membranes, and shaped bodies.

### FIELD OF INVENTION

The present invention relates to a thermoplastic polyurethane (TPU) formulation and its use for producing articles including membranes in an emitter for an irrigation device. Particularly, use of the TPU formulation in production of injection molded products, extrusion products, films, perforated films, membranes, and shaped bodies.

### BACKGROUND OF THE INVENTION

Thermoplastic Polyurethane (TPU) formulations are known and used for forming many articles. TPU formulations include polyols, isocyanate components, chain extenders, fillers, and additives. Appropriate proportion of components are required to achieve desired physical properties of the TPU formulation.

TPU formulations demonstrate physical properties of hardness, shelf life, toughness, flexibility, chemical resistance, etc. These physical properties need to be tailored for specific application of the TPU formulation. Physical properties of TPU formulations are improved by refining crosslinks in TPU formulations when isocyanates are introduced in TPU formulations, preferably molten TPU as disclosed in U.S. Pat. No. 8,318,868 B2. JPA 58-022163 discloses forming of multi-layered structures having a layer of a TPU formulations and layers of ethylene-vinyl alcohol copolymer to have good gas barrier properties. TPU formulations may also be blended with polyoxymethylene for improving impact resistance as disclosed in WO2013188543A1. With alteration of some physical properties, sometime TPU formulations may also demonstrate short comings in other physical properties, such as lack of desired hardness, lesser chemical resistance, lesser shelf life, etc., which limit the usage of the TPU formulations in a lot of applications like irrigation devices, water hoses, etc.

Irrigation devices are used for controlling the flow and distribution of a fluid such as water or water solutions to plants, crops, trees, lawns, etc. Generally, irrigation devices or apparatus include one or more conduits as well as means to control amount of the fluid flowing out of the conduit and to the plants. The conduits include open channels and closed channels such as tubes, hoses, pipes, and their likes. The means to control amount of fluid flowing to the plants include valves, emitters, and the like. The emitters may or may not contain a membrane. The membrane-based emitters generally used are pressure compensating (PC) drip emitters. Generally, non-PC emitters do not have membranes. The PC drip emitters provide for uniform water delivery across the entire length of the irrigation hose, regardless of the pressure drop. The PC drip emitter has a body, a cover, and a membrane/diaphragm. While the body and the cover are normally made of polyethylene and polypropylene, while the membrane/diaphragm part is composed of a more expensive elastic material such as a silicone rubber film as disclosed in U.S. Pat. No. 10,212,896B2. CN101557701A discloses elastic membranes for irrigation emitters made by the foaming elastomer. The membranes are costly, have limited shelf life, and are not easily formed.

CN201420037Y discloses a utility model with a TPU aeration oxygen charging hose for the biochemical treatment of sewage. TPU aeration oxygen charging hose is made of flexible TPU pipe with little pores. However, CN201420037Y neither discloses an irrigation device with a PC drip emitter, nor an independent membrane made of TPU.

Thus, it was an object of the present invention to provide for a TPU formulation having better physical properties. Improvement in the physical properties would facilitate usage of the TPU formulation for forming the membrane in the PC drip emitter of the irrigation device. Object is to provide for the TPU formulation and TPU membrane formed thereof that can be produced in a less complex manufacturing process, provides structural resilience and at same time has a long shelf life, has strong chemical resistance.

### SUMMARY OF THE INVENTION

Surprisingly, it has been found that the above object is met by providing a thermoplastic polyurethane (TPU) formulation.

Accordingly, in one aspect, the present invention is directed to a TPU formed as a reaction product of:
i. a polyol composition comprising at least one polyol having an OH value ranging from 50 mg KOH/g to 500 mg KOH/g:
ii. at least one chain extender;
iii. at least one triol; and
iv. an isocyanate composition comprising a first isocyanate which is an isocyanate with a functionality ranging from 1.5 to 3.0.

In another aspect, the presently claimed invention is directed to an irrigation device comprising an irrigation hose and an emitter defined by a body, a cover, and a membrane, wherein the membrane is made of the TPU.

In another aspect, the presently claimed invention is directed to use of the TPU in production of injection molded products, extrusion products, films, perforated films, membranes, and shaped bodies.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment, but may do. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e. a range of 1 to 10, between 1 to 10 imply that both 1 and 10 are included in the range. For the avoidance of doubt, the applicant shall be entitled to any equivalents according to applicable law.

An aspect of the present invention is directed to thermoplastic polyurethane (TPU) formed as a reaction product of:
i. a polyol composition comprising at least one polyol having OH value ranging from 50 mg KOH/g to 500 mg KOH/g:
ii. at least one chain extender;
iii. at least one triol: and
iv. an isocyanate composition comprising a first isocyanate which is an isocyanate functionality ranging from 1.5 to 3.0.

In the present context, OH value is determined according to DIN EN ISO 4629-1.

The present invention focuses on selecting suitable triol and polyol composition that result in forming TPU by a less complex manufacturing process, provides structural resilience and at same time has a long shelf life, has strong chemical resistance.

The hardness is measured by a durometer based on an ASTM D2240-15el/DIN 53505 testing standard. Shore “A” scale is used to determine the hardness in a value from 0 to 100 where higher value indicates a harder material.

The TPU has a shore A hardness from 30 to 100 determined according to ASTM D2240-15el/DIN 53505.

### Polyol Composition

In an embodiment, the polyol composition comprises at least one polyol having an OH value ranging from 20 mg KOH/g to 500 mg KOH/g.

Preferably, the polyol has OH value ranging from 20 mg KOH/g to 500 mg KOH/g , or from 20 mg KOH/g to 450 mg KOH/g, or from 20 mg KOH/g to 350 mg KOH/g, or from 20 mg KOH/g to 300 mg KOH/g, or from 20 mg KOH/g to 250 mg KOH/g, or from 20 mg KOH/g to 200 mg KOH/g. More preferably, the polyol has OH value ranging from 30 mg KOH/g to 200 mg KOH/g, or from 40 mg KOH/g to 200 mg KOH/g, or from 50 mg KOH/g to 200 mg KOH/g.

Suitable polyols in the polyol composition are preferably selected from Polytetrahydrofurane (PolyTHF), polyether polyols, polyester polyols, or polycarbonate polyols. In one embodiment, the polyol comprises a Poly THF.

Poly THF is well known and available in various molecular weights commercially.

Preferred PolyTHF used are with the molecular weight distribution from 500 g/mol to 2500 g/mol, or from 550 g/mol to 2500 g/mol, or from 600 g/mol to 2500 g/mol, or from 625 g/mol to 2500 g/mol. In yet another embodiment, the Poly THF used are with the molecular weight distribution from 625g/mol to 2450 g/mol, or from 625 g/mol to 2400 g/mol, or from 625 g/mol to 2350 g/mol, or from 625 g/mol to 2300 g/mol, or from 625 g/mol to 2250 g/mol, or from 625 g/mol to 2200 g/mol, or from 625 g/mol to 2150 g/mol, or from 625 g/mol to 2100 g/mol, or from 625 g/mol to 2050 g/mol. A more preferred PolyTHF is with molecular weight from 625 g/mol to 2050 g/mol. An even more preferred PolyTHF is with molecular weight in range of 625 g/mol to 675 g/mol. An even more preferred PolyTHF is with molecular weight in range of 975 g/mol to 1025 g/mol. An even more preferred PolyTHF is with molecular weight in range of 1950 g/mol to 2050 g/mol.

Preferred the polyol composition includes two different polyols with the molecular weight ratio in range of 1:10 to 10:1, or in range of 1:9 to 9:1 or in the range of 1:8 to 8:1 or in range of 1:7 to 7:1 or in the range of 1:6 to 6:1, or in the range 1:5 to 5:1 or in the range 1:4 to 4:1 or in the range of 1:3 to 3:1 or in the range of 1:2 to 2:1. More preferred the polyol composition includes two polyols with molecular weight ratio of 1:1.

Another preferred the polyol composition is a PolyTHE mixture (i) based on the mixture of at least two, preferably separately prepared Poly THF. By the expression “at least two PolyTHF ” it is meant that two different PolyTHF are used, which have different mean molecular weight ranges Preferably, the polyol composition includes a first PolyTHF of molecular weight range of 975 g/mol to 1025 g/mol and a second PolyTHF of molecular weight range of 1950 g/mol to 2050 g/mol in weight ratio of 1:1.

### Chain Extender

In an embodiment, the chain extender has a molecular weight of less than 499 g/mol. In the context of the present invention, the chain extender is understood to mean a compound having at least two functional groups reactive toward isocyanates, for example hydroxyl groups, amino groups or thiol groups, and a molecular weight Mw of less than 499 g/mol. At the same time, in the context of the present invention, the polyol composition is also free of compounds of this kind.

Preferably, the chain extenders have a molecular weight less than 300 g/mol, or from 10 g/mol to 210 g/mol. Another preferred chain extender has a molecular weight from 50 g/mol to 150 g/mol, or from 50 g/mol to 120 g/mol, or from 60 g/mol to 120 g/mol.

Suitable chain extenders can be selected from ethylene glycol, 1,2-propanediol, 1,3-propanediol, 1-5 pentanediol, 1,6-hexanediol, 1,10-decanediol, 1,2-dihydroxycyclohexane, 1,3-dihydroxycyclohexane, 1,4-dihydroxycyclohexane, diethylene glycol, 1,4-butanediol, bis(2-hydroxy-ethyl)hydroquinone, dipropylene glycol, glycerol, diethanolamine, and triethanolamine. Preferably, the chain extender can be selected from 1,2-ethylene glycol, 1,3-propylene glycol, 1,4 butane diol, 1,5-pentane diol, 1,6-hexane diol, Hydroquinone Bis (2-hydroxyethyl) Ether (HQEE), or/and hydroxyethylether of resorcinol or 1,3-Bis (2-hydroxyethyl) resorcinol (HER).

More preferably, the HQEE is used as a chain extender to aid compression set resistance.

In another preferred embodiment, the HER is used as a chain extender to aid compression set resistance.

In the context of the present invention, the amount of the chain extender and the polyol composition may vary within wide ranges. Preferably, the weight ratio between the chain extender and the polyol composition is from 0.015:1.0 to 0.15:1.0. In another embodiment, the weight ratio between the chain extender and the polyol composition is from 0.015:1.0 to 0.14:1.0, or from 0.015:1.0 to 0.13:1.0, or from 0.015:1.0 to 0.12:1.0. In still another embodiment, the weight ratio between the chain extender and the polyol composition is from 0.015:1.0 to 0.11:1.0, or from 0.016:1.0 to 0.11:1.0, or from 0.017:1.0 to 0.11:1.0.

For the preparation of the TPU, a suitable isocyanate index is required to be maintained. The index is defined here as the ratio of the total for number of isocyanate groups of the isocyanate composition used in the reaction to the isocyanate-reactive groups, i.e., the groups of polyol composition and the chain extender. At an index of 100, there is one active hydrogen atom per isocyanate group of the isocyanate composition. At indices exceeding 100, there are more isocyanate groups than isocyanate-reactive groups. In an embodiment, the index for preparing the TPU is from 90 to 110.

At least one triol

In one embodiment, the at least one triol is selected from the list comprising castor oil and/or a trifunctional alcohol. The at least one triol is in an amount from 0.001 wt.-% to 10.0 wt .-%.

Preferably, the at least one triol is a trifunctional alcohol.

More preferably, the trifunctional alcohol is trimethylolpropane (TMP). The trimethylpropane is in an amount from 0.001 wt.-% to 10.0 wt.-%, or from 0.001 wt.-% to 5.0 wt.-%, or from 0.001 wt.-% to 2.5 wt.-%, or from 0.001 wt.-% to 1.5 wt.-%. In yet other embodiment, the trimethylpropane is in an amount from 0.005 wt.-% to 0.09 wt.-%, or from 0.01 wt.-% to 0.09 wt.-%, or from 0.02 wt.-% to 0.09 wt.-%, or from 0.03 wt.-% to 0.09 wt.-%, or from 0.001 wt.-% to 0.09 wt.-%.

In another preferred embodiment, the at least one triol is castor oil. The at least one triol which is castor oil, is in an amount from 0.001 wt.-% to 10.0 wt.-%, or from 0.001 wt.-% to 7.5.0 wt.-%, or from 0.001 wt.-% to 5.0 wt.-%.

Isocyanate Composition

In one embodiment, the isocyanate composition comprises a first isocyanate which is an isocyanate having an isocyanate functionality ranging from 1.5 to 3.0. Preferably, the isocyanate functionality of the first isocyanate ranges from 1.6 to 3.0, or from 1.7 to 3.0, or from 1.8 to 3.0, or from 1.9 to 3.0. More preferably, the isocyanate functionality of the first isocyanate ranges from 1.9 to 2.9, or from 1.9 to 2.8, or from 1.9 to 2. 7, or from 1.9 to 2.6, or from 1.9 to 2.5, or from 1.9 to 2.4. More preferably, the isocyanate functionality of the first isocyanate ranges from 1.90 to 2.30, or from 1.90 to 2.20.

The isocyanate content of the first isocyanate is in an amount from 1 wt.-% to 50 wt .-%. Preferably, the isocyanate component of the first isocyanate is from 1 wt.-% to 40 wt.-%, or from 4 wt.-% to 40 wt.-%, or from 6 wt.-% to 40 wt.-%, or from 8 wt.-% to 40 wt.-%. More preferably, the isocyanate component of the first isocyanate is from 10 wt.-% to 40 wt.-%, or from 10 wt.-% to 38 wt.-%, or from 10 wt.-% to 36 wt.-%.

Preferably, the first isocyanate is selected from a 2,2′-, 2,4′-and/or 4,4′-diisocyanate, a hexamethylene diisocyanate (HDI), or Hydrogenated MDI.

Preferably, the first isocyanate has an isocyanate content in range from 27 wt. % to 32 wt. %.

In another embodiment, the isocyanate composition further comprises a second isocyanate having an isocyanate functionality of at least 2.0, said second isocyanate being different than the first isocyanate. Suitable second isocyanates have an isocyanate content of at least 5.0 wt.-%. Preferably, the second isocyanate in the isocyanate composition have an isocyanate content in range from 5 wt. % to 40 wt. %, or in range from 6 wt. % to 30 wt. %, or in range from 7 wt. % to 20 wt. %, the said second isocyanates being different than the first isocyanate.

Preferably, the second isocyanate in the isocyanate composition is selected from a prepolymer based on carbodiimide-modified diphenylmethane 2,2′-, 2,4′-and/or 4,4′-diisocyanate. In an embodiment the second isocyanate is a carbodiimide-modified diphenylmethane 4,4′-diisocyanate.

Isocyanates suitable as second isocyanate in the isocyanate composition have an isocyanate content from 7 wt. % to 15 wt. % and a viscosity at 25° C. from 20 to 100 cps determined according to DIN EN ISO 3219.

In one embodiment, the isocyanate composition comprises a mixture of the first isocyanate and the second isocyanate. The weight ratio between the first isocyanate and the second isocyanate in the isocyanate composition is from 2.0:1.0 to 1.0: 2.0. Preferably, the weight ratio between the first isocyanate and the second isocyanate in the isocyanate composition is from 2.0:1.0 to 1.0:1.5 or from 2.0:1.0 to 1.0:1.3, or from 2.0:1.0 to 1.0:1.0. More preferably, the weight ratio between the first isocyanate and the second isocyanate in the isocyanate composition is from 1.9:1.0 to 1.0:1.0, or from 1.8:1.0 to 1.0:1.01, or from 1.7:1.0 to 1.0:1.0.

Additives:

In an embodiment, the TPU is formed as a reaction product of mixture that further comprises a catalyst and/or at least one additive or catalyst. These substances are known per se to those skilled in the art. According to the invention, it is also possible to use combinations of two or more catalysts and/or additives.

In an embodiment, the additives in the mixture can be selected from surface-active substances, flame retardants, nucleating agents, oxidation stabilizers, lubricants, mold release agents, dyes, pigments, dyes, flame retardants, hindered amine light stabilizers, ultraviolet light absorbers, stabilizers, ultra violet stabilizers, hydroxy stabilizers, plasticizers, epoxy plasticizers, chain regulator, polyethylene wax, antioxidants, defoamers, internal release agents, desiccants, blowing agents and anti-static agents or combinations thereof. Further details regarding additives can be found, for example, in the Kunststoffhandbuch, Volume 7, “Polyurethane” Carl-Hanser-Verlag Munich, 1st edition, 1966 2nd edition, 1983 and 3rd edition, 1993.

Suitable catalysts are likewise known in principle from the prior art. Suitable catalysts are, for example, organic metal compounds selected from the group consisting of tin organyls, titanium organyls, zirconium organyls, hafnium organyls, bismuth organyls, zinc organyls, aluminum organyls and iron organyls, for example tin organyl compounds, preferably tin dialkyls such as dimethyltin or diethyltin, or tin organyl compounds of aliphatic carboxylic acids, preferably tin diacetate, tin dilaurate, dibutyltin diacetate, dibutyltin dilaurate, bismuth compounds such as bismuth alkyl compounds or the like, or iron compounds, preferably iron(MI) acetylacetonate, or the metal salts of the carboxylic acids, for example tin(II) isooctoate, tin dioctoate, titanic esters or bismuth(III) neodecanoate.

In another embodiment, the catalysts are selected from tin compounds and bismuth compounds, further preferably tin alkyl compounds or bismuth alkyl compounds. The catalysts are typically used in the mixture in amounts less than 2000 ppm, or from 1 ppm to 1000 ppm, or from 2 ppm to 500 ppm.

Process of Forming the TPU

In an embodiment, the TPU is formed as the reaction product of the mixture comprising the polyol, the at least one chain extender, at least one triol and an isocyanate composition.

TPU

In an embodiment, the properties of the TPU may vary within wide ranges according to the application. In a preferred embodiment, the TPU has a Shore A hardness of from 10.0 A to 100.0 A, determined according to ASTM D2240-15el. In a more preferred embodiment, the Shore A hardness is from 20.0 A to 100.0 A, or from 30.0 A to 100.0 A. In a further preferred embodiment, the TPU has a shore A hardness from 50.0 A to 90.0 A or from 65.0 A to 80.0 A.

Physical properties as desired Shore A hardness, strong chemical resistance, and long shelf life of the TPU composition are surprisingly achieved by using the composition with polyol and the at least one triol.

Irrigation Device

In an embodiment, the irrigation device comprises an emitter and an irrigation hose. Irrigation devices are well known in the art as the drip irrigation systems of U.S. Pat. No. 4,307,841 and U.S. Pat. No. 4,210,287.

Preferably, the emitter is a membrane-based emitter. The emitter is defined by a body, a cover and at least one membrane. The emitter unit of the irrigation device are described in U.S. Pat. No. 4,413,786. The membranes are alternatively referred in the art as diaphragms.

Preferably, the membrane is made of a TPU.

More preferably, the emitter is a pressure compensating drip emitter.

In another embodiment, the irrigation hose is defined by a conduit or a pipe through which water flows inside. In an embodiment the irrigation hose is flexible to take shape of a tube while water flows through and retracts to a flat shape in absence of water.

In yet another embodiment, the emitter and the hose are selected from inline connection, online connection, or terminal connection. Preferably, the pressure compensating emitters are defined as “in-line” emitters or the “on-line” emitters. The “in-line” emitters are inside the water hose. The “on-line” emitters are on the outside of the water hose. Alternatively, the emitter and the hose connection is defined as a single piece-single material emitter. Materials for an all TPU emitter is manufactured by a simpler and less expensive process.

In an embodiment, the TPU is produced and provided into an injection molding apparatus. The injection molding apparatus then injection molds the precise part needed as membrane for irrigation device. In an alternate embodiment, TPU is provided into a film/sheet converter. Sheets of TPU are extruded and precise parts are die cut from the TPU sheets. Scrap material can be recycled back into the extrusion process to reduce waste. The TPU sheets are them fabricated into membrane for irrigation device. Membrane formed is associated with improved compression set performance. The TPU membrane is also associated with improved recyclability and resistance to chemicals used to flush our irrigation hose. The TPU membrane retains resistance to chemicals at elevated Temperature of 49° C. The membrane also has low activation pressure. The PC emitters with TPU membrane in the irrigation devices are recycled readily.

Preferably, the irrigation device is the irrigation device with a pressure compensating drip emitter.

Use

In an embodiment, the TPU is used in production of injection molded products, extrusion products, films, perforated films, membranes, and shaped bodies.

For the purpose of the invention, the procedure for measuring the Chemical Resistance was performed as per METHOD A.

METHOD A

Chemical Resistance of the membrane made of the TPU in the irrigation device is tested for Nitric Acid, Sulfuric Acid and Phosphoric Acid at pH 3. The Irrigation device is flushed and then injected with one of the Acid to achieve concentration of 0.6% in treated water. Chemical resistance is measured based on the Acid treatment disclosed in Netafilm Drip Irrigation System Maintenance Handbook V 001.02-2016.

For the purpose of the invention, stability assessment of the TPU was performed by METHOD B.

METHOD B

TPU is immersed in solution of Nitric acid, sulfuric acid, or phosphoric acid for a period of 28. Aging is performed at 49° C. with the Acids at pH 3.

METHOD C

METHOD C is the Gel Permeation Chromatographic (GPC) Analysis of Thermoplastic Polyurethane (TPU) herein. The sample is dissolved in mobile phase (dimethylformamide containing lithium bromide) and injected into the liquid chromatograph. High-resolution GPC columns are used to separate components on the basis of their size in solution. A thermostated differential refractometer is used as detector. Narrow distribution polystyrene standards are used to prepare the standard curve. Number average molecular weight (Mₙ), weight average molecular weight (M_{w}), peak molecular weight (M_{P}), and polydispersity (D) are calculated using the standard curve.

The present invention is illustrated in more detail by the following embodiments and combinations of embodiments which result from the corresponding dependency references and links:

I. A thermoplastic polyurethane (TPU) formed as a reaction product of a mixture comprising:
i. a polyol composition comprising at least one polyol having an OH value ranging from 50 mg KOH/g to 200 mg KOH/g:
ii. at least one chain extender;
iii. at least one triol: and
iv. an isocyanate composition comprising a first isocyanate which is an isocyanate functionality ranging from 1.5 to 3.0.

II. The TPU of embodiment I, wherein the TPU has a shore A hardness from 30 to 100 determined according to ASTM D2240-15el/DIN 53505.

III. The TPU of embodiments I or II, wherein, the at least one polyol is selected from Polytetrahydrofurane (Poly THF) with molecular weight from 625 g/mol to 2050 g/mol.

IV. The TPU of embodiments I to III, wherein the polyol composition includes two polyols with the molecular weight ratio in range of 1:9 to 9:1 .

V. The TPU of embodiments I to IV, wherein the polyol composition includes two polyols with molecular weight ratio of 1:1.

VI. The TPU of embodiments I to V, wherein the chain extender has a molecular weight ranging from 60 g/mol to 120 g/mol.

VII. The TPU of embodiments I to VI, wherein the chain extender is selected from 1,2-ethylene glycol , 1,3-propylene glycol, 1,4 butane diol, 1,5-pentane diol, 1,6-hexane diol , Hydroquinone Bis (2-hydroxyethyl) Ether (HQEE), and/or 1,3-Bis (2-hydroxyethyl) resorcinol (HER).

VIII. The TPU of embodiments I to VII, wherein the triol is a trifunctional alcohol, preferably trimethylolpropane.

IX. The TPU of claims I to VIII, wherein the first isocyanate is in an amount of 1 to 50 wt .-% of the total composition.

X. The TPU of embodiments I to IX, wherein the first isocyanate is selected from a 4,4′-methylenediphenyl diisocyanate and 2,4′-methylenediphenyl diisocyanate.

XI. The TPU of embodiments I to X, wherein the isocyanate composition further comprises second isocyanate which is a carbodiimide-modified isocyanate having an isocyanate functionality ranging from 1.90 to 3.0.

XII. The TPU of embodiments I to XI, wherein the TPU further comprises a catalyst and/or at least one additive is selected from selected from surface-active substances, flame retardants, nucleating agents, oxidation stabilizers, lubricants, dispersing agents, and mold release agents, dyes, pigments, stabilizers against hydrolysis, light, heat or discoloration, inorganic and/or organic fillers, reinforcing materials, plasticizers, antioxidants or combination thereof .

XIII. An irrigation device comprising:
a. an emitter defined by a body, a cover and at least one membrane; and
b. an irrigation hose, wherein the membrane is made of a TPU as disclosed in embodiments I to XII.

XIV. The irrigation device of embodiment XIII, wherein the emitter is a pressure compensating emitter.

XV. The irrigation device of embodiments XIII or XIV, wherein connection from the emitter and the hose is selected from inline connection, online connection, or terminal connection.

XVI. Use of the TPU of embodiment I to XV for production of injection molded products, extrusion products, films, perforated films, membranes, and shaped bodies.

### EXAMPLES

The present invention is further illustrated in combination with the following examples. These examples are provided to exemplify the present invention but are not intended to restrict the scope of the presently claimed invention in any way. The terms and abbreviations in the examples have their common meanings. For example, “ %”, “ % NCO”, “Eq. wt.”, “Eq.”, “° C.”, “wt. %”, “ % w/w”, “ % w/v” and “gm” represent “percentage”, “isocyanate content/percent Nitrogen Carbon Oxygen”, “Equivalent Weight”, “Equivalents”, “degree Celsius”, “percent by weight”, “percent weight by weight”, “percent weight by volume” and “gram” respectively.

COMPOUNDS
POLYOL

| | |
|---|---|
| Polyol 1 | Polytetrahydrofurane of Molecular Weight/Mol from |
| | 975 to 1025, Hydroxyl number of 109.5 to 115.1 |
| | mgKOH/g, Glass transition point Tg −77° C. |
| Polyol 2 | Polytetrahydrofurane of Molecular Weight/Mol from |
| | 1950 to 2050, Hydroxyl number of 54.7 to 57.5 |
| | mgKOH/g, Glass transition point Tg −77° C. |

CHAIN EXTENDER

| | |
|---|---|
| Diol 1a | Hydroquinone Bis (2-hydroxyethyl) Ether (HQEE) |
| Diol 1b | 1,4-Butanediol |

TRIOL

| | |
|---|---|
| Triol 2a | Castor oil FSG |
| Triol 2b | Trimethylolpropane |

ISOCYANATE

| | |
|---|---|
| Isocyanate 1a1 | 4,4′ Diphenylmethane Diisocyanate, NCO content 35 |
| | wt.-%, Viscosity @ 25° C., cps - 33 |
| Isocyanate 1b | Carbodiimide Modified MDI with NCO % 29.5, |
| | Nominal Functionality of 2.2, Viscosity @25 Dec C |
| | (cps) of 40 |
| Isocyanate 1a2 | HDI (hexane di isocyanate) |

ADDITIVES

| | |
|---|---|
| Additive/ | Blend of 2 phenolic Antioxidants: |
| Antioxidant1 | a pentaerythritol tetrakis[3-[3,5-di-tert-butyl-4- |
| | hydroxy-phenyl]propionate and |
| | a N,N′-(hexane-1,6-diyl)bis[3-(3,5-di-tert-butyl-4- |
| | hydroxy-phenyl)propanamide]. |
| Additive/ | (pentaerythritol tetrakis[3-[3,5-di-tert-butyl-4- |
| Antioxidant2 | hydroxyphenyl]propionate) |
| Additive/ | Ester of montanic acids with multifunctional alcohols. |
| Lubricant | Montanic acids in raw montan wax are straight chain, |
| | unbranched monocarboxylic acids with a chain length |
| | in the range of C28-C32 |
| Additive/ | N,N′-Ethylenebis(stearamide) |
| Polyethylene wax | |
| Polyamide | Polybutylene Terephthalate |
| Polyamide | Talc, Antioxidant 1, glycolube, Ethylene bis |
| Master batch1 | stearamide (EBS) wax |
| Polyamide | Talc, Antioxidant 1, glycolube |
| Master batch2 | |
| plasticizer | Epoxy plasticizer |
| Hydroxyl | Hydrolysis stabilizer, (Polymer based on 1,3-Bis(1- |
| stabilizer | isocyanato-1-methylethyl)benzene) \| NCO-terminated |
| | TMXDI-carbodiimide, 7% Isocyanate, 14% |
| | Carbodiimide |
| UV stabilizer1 | Benzotriazole UV absorber |
| UV stabilizer2 | Polymeric Hindered Amine Light Stabilizer |
| Chain Regulator | C6-C22 linear alcohol/Octyl Alcohol/Caprylic Alcohol |

Standard method

| | |
|---|---|
| DIN EN | OH value (Determination of hydroxyl value) |
| ISO 4629-1 | Determination of hydroxyl value - Part 1: Titrimetric |
| | method without using a catalyst (ISO 4629-1: 2016) |
| ASTM | Shore hardness (Standard Test Method for Rubber |
| D2240-15e1 | Property--Durometer Hardness) Published: Jun. 15, 2021 |
| ASTM D412 | Tensile strength, and strain at break (Standard Test Methods |
| | for Vulcanized Rubber and Thermoplastic Elastomers- |
| | Tension) DOI: 10.1520/D0412-16R21 |
| DIN 53504 | Abrasion resistance (2017 Edition, March 2017 Testing of |
| | rubber - Determination of tensile strength at break, tensile |
| | stress at yield, elongation at break and stress values in a |
| | tensile test) |

General Synthesis of TPU as Per Disclosure

Mixtures were prepared using the aforementioned raw materials. with stirring in a reaction vessel. The start temperature was 80° C. On attainment of a reaction temperature of 110° C.

the mixture was poured onto a hotplate heated to 125° C., and the TPU sheet obtained was pelletized after the heat treatment (15 h, 80° C.).

General Synthesis of TPUs Using Reactive Extrusion Method

The second housing of a ZSK 32 twin-shaft extruder from Werner & Pfleiderer, Stuttgart, having a process length of 56 D, was charged with the chain extender (dosed separately in Zone 5) and polyol at a charge temperature of 160° C. and, separately therefrom, the isocyanate was metered into the second housing at a charge temperature of 65° C., along with the additives (added in first zone). The speed of the twin screw was 260 rpm. The set temperature values for the housing were, in flow direction, (see protocol) 200° C. in the first third of the screw, 170° C. in the second third of the screw, and 190° C. in the last third of the screw. The expulsion rate was 20 kg/h. After the melt chopping by underwater pelletization and integrated centrifugal drying, the pellets were subjected to final drying at about 80° C. to 90° C.

The injection molding was done on a 30 mm hydraulic driven IM machine with 3 Zones and the screw with 70 rpm. The temperature profile in Zones 1, 2 3, and the die were: 200° C., 210° C., 210° C., and 215° C., respectively. The back pressure was 32 bars and the injection pressure was 35 bars. Form temperature was 25° C. The test plaques produced had thickness of 2 mm and 6 mm, which were subsequently annealed for 20 h at a temperature of 100° C., prior to physical testing.

The components and properties of the TPUs obtained are compiled in Tables 1 to 3. Examples (El) to (E12) provides for TPU compositions as disclosed in Table 1 to 3.

TABLE 1
TPU Examples (E1) to (E4)

| Category | E1 | E2 | E2a | E2b | E3 | E4 |
|---|---|---|---|---|---|---|
| Polyol 1 | 500 g \| 34.37% | 500 g \| 34.3% | 1000 g \| 67.8% | 1000 g \| 67.6% | 500 g \| 34% | 500 g \| 34% |
| Polyol 2 | 500 g \| 34.3% | 500 g \| 34.3% | | | 500 g \| 34% | 500 g \| 34% |
| Diol 1a | | 109.1 g \| 7.5% | 85.3 g \| 5.78% | 85.58 g \| 5.78% | 107.1 g \| 7.3% | |
| Diol 1b | 65.38 g \| 4.5% | | | | | 63.6 g \| 4.4% |
| Isocyanate 1a1 | 372 g \| 25.5% | 328.2 g \| 22.5% | 367.3 g \| 22.83% | 371.33 g \| 25.1% | 211.7 g \| 14.4% | 238.6 g \| 16.2% |
| Isocyanate 1b | | | | | 129.7 g \| 8.8% | 146.2 g \| 9.9% |
| Additive/ | 14.59 g \| 1% | 14.59 g \| 1% | 14.7 g \| 1% | 14.79 g \| 1% | 14.7 g \| 1% | 14.71 g \| 1% |
| Antioxidant1 | | | | | | |
| Additive/ | 7.3 g \| 0.5% | 7.3 g \| 0.5% | 7.37 g \| .5% | 7.4 g \| 5% | 7.35 g \| 0.5% | 7.35 g \| 0.5% |
| Lubricant | | | | | | |
| Mass content | 17.2% | 17.2% | 13.3% | 13.3% | 17.2% | 17.2% |
| of the hard | | | | | | |
| phase | | | | | | |
| Total | 1459.3 | 1459.37 | 1474.83 | 1479.1 | 1470.6 | 1470.6 |
| Mass (g) | | | | | | |

Examples (E1) to (E4). (E9) and (E10) provide for TPUs formed without the Triol 2a or Triol 2b.

TABLE 2
TPU Examples (E5) to (E8)

| Category | E5 | E6 | E7 | E8 |
|---|---|---|---|---|
| Polyol 1 | 500 g \| | 500 g \| | 500 g \| | 500 g \| |
| | 34.3% | 34.3% | 30.1% | 28.8% |
| Polyol 2 | 500 g \| | 500 g \| | 500 g \| | 500 g \| |
| | 34.3% | 34.3% | 30.1% | 28.8% |
| Diol 1b | 61.94 g \| | 58.51 g \| | 74.62 g \| | 89.02 g \| |
| | 4.2% | 4.% | 4.5% | 5.1% |
| Triol 2a | 3.95 g \| | 7.89 g \| | | |
| | 0.3% | 0.5% | | |
| Triol 2b | | | 1.13 g \| | 1.35 g \| |
| | | | 0.07% | 0.08% |
| Isocyanate 1a1 | 371.5 g \| | 370.98 g \| | 561.15 g \| | 617.97 g \| |
| | 25.5% | 25.4% | 33.8% | 35.6% |
| Additive/ | 14.59 g \| | 14.59 g \| | 16.62 g \| | 17.34 g \| |
| Antioxidant1 | 1% | 1% | 1% | 1% |
| Additive/ | 7.3 g \| | 7.3 g \| | 8.31 g \| | 8.67 g \| |
| Lubricant | 0.5% | 0.5% | 0.5% | 0.5% |
| Mass content of the hard | 17.18% | 17.18% | 17.48% | 19.98% |
| phase | | | | |
| Total Mass (g) | 1459.27 | 1459.27 | 1661.83 | 1734.35 |

Example (E9) provides for TPU with modified hard phase while (E10) provides for Aliphatic TPU with modified hard phase.

TABLE 3
TPU Examples (E9) to (E11)

| Category | E9 | E10 | E11 | E12 |
|---|---|---|---|---|
| Polyol 1 | 1000 g \| | 1000 g \| | 500 g \| | 500 g \| |
| | 59.19% | 62.89% | 34.64% | 33.59% |
| Polyol 2 | | | 500 g \| | 500 g \| |
| | | | 34.64% | 33.59% |
| Diol 1b | 18.25 g \| | 19.56 g \| | 66.37 g \| | 78.26 g \| |
| | 1.08% | 1.23% | 4.6% | 5.26% |
| Triol 2b | | | 1 g \| | 1.0 g \| |
| | | | 0.07% | 0.067% |
| Isocyanate 1a1 | 313.17 g \| | | 372 g \| | 405 g \| |
| | 18.54% | | 25.776% | 27.21% |
| isocyanate 1a2 | | 212.35 g \| | | |
| | | 13.35% | | |
| Additive/ | 10.14 g \| | | | |
| Antioxidant1 | 0.6% | | | |
| Additive/ | | | 3.605 g \| | 3.72 g \| |
| Antioxidant2 | | | 0.25% | 0.250% |
| Additive/ | | | 0.435 g \| | 0.45 g \| |
| Polyethylene wax | | | 0.030% | 0.030% |
| Polyamide | 270.95 g \| | 303.41 g \| | | |
| | 16.04% | 19.08% | | |
| Polyamide Master | 50.71 g \| | | | |
| batch1 | 3.0% | | | |
| Polyamide Master | | 31.8 g \| | | |
| batch2 | | 2% | | |
| Plasticizer | 8.45 g \| | | | |
| | 0.50% | | | |
| Hydroxyl | 16.06 g \| | 15.11 g \| | | |
| stabilizer | 0.95% | 0.95% | | |
| UV stabilizer1 | | 3.98 g \| | | |
| | | 0.25% | | |
| UV stabilizer2 | | 3.98 g \| | | |
| | | 0.25% | | |
| Chain regulator | 1.69 g \| | | | |
| | 0.1% | | | |
| Mass content of the hard | | | 17.48% | 19.98% \| |
| phase | | | (251.7 g) | (296.6 g) |
| Total Mass | 1689.42 | 1590.19 | 1443.4 | 1488.4 |

Example (E5) and (E6) provides for TPU prepared using Diol 2a while Examples (E7), (E8), (E11) and (E12) provide for TPU with Diol 2b. Examples (E7), (E8), (E11) and (E12) are associated with improved shore hardness, tensile strength, strain at rupture %, Tear strength, Abrasion and compression set performance.

Physical property data of examples are denoted in Table 4 below:

TABLE 4

| | E11 | E12 |
|---|---|---|
| | (1170ACS TR1 | (1175ACS TR1 |
| Physical Properties | 310865) | 310874) |
| Density (g/cm³) | 1.08 | 1.09 |
| Shore hardness (Shore A) | 74 | 78 |
| Tensile strength (Mpa) | 35 | 37 |
| Strain at rupture (%) | 491 | 482 |
| Tear strength (KN/m) | 20 | 23 |
| Abrasion (mm3) | 51 | 46 |
| Compression set (24 h/70° C./30) 15% | 19 | 17 |
| Compression set (24 h/70° C./30) 30% | 19 | 18 |

The membranes based on the TPU Examples were exposed to harsh chemicals that are used in irrigation lines for cleaning. Harsh chemicals include nitric acid, sulfuric acid and phosphoric acid. The stability of TPU was evaluated for the harsh chemicals by performing aging studies for 28 days period. The membranes based on E1 (1170A10) and E11 (1170A10CS TR1) were subjected to temperature: 120° F. and each such membrane was suspended in 3 solutions with pH 3 nitric acid, pH 3 sulfuric acid, and pH 3 phosphoric acid. 120° F. was chosen as an extreme temperature and harsher than the materials would traditionally experience. The tensile strength (in psi and % change) of the membranes based on El and E11 after aging over 28 days was evaluated by DIN 53504 S2 and is denoted in Table 5 below. Evaluation of the tensile strength required that the samples be subjected for destructive testing. Multiple samples form same batch of the El and E11 formulations were subjected for the evaluation resulting into slight variation across the values over DO to D28.

TABLE 5

| Acid | Ex | D 0 | D 3 | D 21 | D 28 |
|---|---|---|---|---|---|
| Nitric | E1 | 4245 (100%) | 4139 (97%) | 3868 (91%) | 3919 (92%) |
| Acid | | | | | |
| Nitric | E11 | 3654 (100%) | 3077 (84%) | 3084 (84%) | 3111 (85%) |
| Acid | | | | | |
| Sulfuric | E1 | 4245 (100%) | 4167 (98%) | 3928 (93%) | 3814 (90%) |
| acid | | | | | |
| Sulfuric | E11 | 3654 (100%) | NA | 3589 (98%) | 3064 (84%) |
| acid | | | | | |
| Phos- | E1 | 4245 (100%) | 4185 (99%) | 3979 (94%) | 3752 (88%) |
| phoric | | | | | |
| acid | | | | | |
| Phos- | E11 | 3654 (100%) | NA | 3610 (99%) | 3370 (92%) |
| phoric | | | | | |

1. A thermoplastic polyurethane (TPU) formed as a reaction product of a mixture, comprising:
a. a polyol composition comprising at least one polyol having an OH value ranging from 50 mg KOH/g to 500 mg KOH/g;
b. at least one chain extender;
c. at least one triol; and
d. an isocyanate composition comprising a first isocyanate which has an isocyanate functionality ranging from 1.5 to 3.0.

2. The TPU of claim 1, wherein the TPU has a shore A hardness from 30 to 100 determined according to ASTM D2240-15el/DIN 53505.

3. The TPU of claim 1, wherein the at least one polyol is a polytetrahydrofuran (PolyTHF) with a molecular weight from 625 g/mol to 2050 g/mol.

4. The TPU of claim 1, wherein the polyol composition includes two polyols with a molecular weight ratio in a range of 1:9 to 9:1.

5. The TPU of claim 1, wherein the polyol composition comprises two polyols with a molecular weight ratio of 1:1.

6. The TPU of claim 1, wherein the at least one chain extender has a molecular weight ranging from 60 g/mol to 120 g/mol.

7. The TPU of claim 1, wherein the at least one chain extender is at least one selected from the group consisting of 1,2-ethylene glycol, 1,3-propylene glycol, 1,4 butane diol, 1,5-pentane diol, 1,6-hexane diol, hydroquinone bis (2-hydroxyethyl) ether (HQEE), and 1,3-bis (2-hydroxyethyl) resorcinol (HER).

8. The TPU of claim 1, wherein the at least one triol is a trifunctional alcohol.

9. The TPU of claim 1, wherein the first isocyanate is in an amount of 1 to 50 wt.-% of the total composition.

10. The TPU claim 1, wherein the first isocyanate is at least one selected from the group consisting of a 4,4′-methylenediphenyl diisocyanate and a 2,4′-methylenediphenyl diisocyanate.

11. The TPU of claim 1, wherein the isocyanate composition further comprises a second isocyanate which is a carbodiimide-modified isocyanate having an isocyanate functionality ranging from 2.0 to 3.0.

12. The TPU of claim 1, wherein the TPU further comprises a catalyst and/or at least one additive selected from the group consisting of surface-active substances, flame retardants, nucleating agents, oxidation stabilizers, lubricants, dispersing agents, mold release agents, dyes, pigments, stabilizers against hydrolysis, light, heat or discoloration, an inorganic filler, an organic filler, reinforcing materials, plasticizers, antioxidants, and combinations thereof.

13. An irrigation device, comprising:
a. an emitter defined by a body, a cover, and at least one membrane: and
b. an irrigation hose,
wherein the at least one membrane is made of a TPU as claimed in claim 1.

14. The irrigation device of claim 13, wherein the emitter is a pressure compensating emitter.

15. The irrigation device of claim 13, wherein a connection between the emitter and the irrigation hose is an from inline connection, an online connection, or a terminal connection.

16. A method for producing injection molded products. extrusion products. films. perforated films. membranes. and shaped bodies. the method comprising: shaping a TPU of claim 1.
